(19) United States
(12) Patent Application Publication
(10) Pub. No.: US 2015/0268418 A1
(43) Pub. Date: Sep. 24, 2015

(54) EXPANDED BEAM INTERCONNECTOR

(71) Applicants: APPLIED MICRO CIRCUITS CORPORATION, (US); VOLEX PLC, LONDON (UK)

(72) Inventor: Benoit Sevigny, Mountain View, CA (US)

(21) Appl. No.: 13/654,493

(22) Filed: Oct. 18, 2012

Related U.S. Application Data
(60) Provisional application No. 61/706,653, filed on Sep. 27, 2012.

(51) Int. Cl. G02B 6/26; G02B 6/32

(52) U.S. Cl. CPC G02B 6/26; G02B 6/32

(57) ABSTRACT

Methods and systems for facilitating electromagnetic communication are provided. The methods and systems include expanding an optical signal to a predetermined size based on occlusion particle parameters. A connector can be configured to alter beam parameters to increase density, enable visual identification of occlusions which increase loss, and decrease sensitivity to contaminants. Loss associated with a connector can be controlled based on beam expansion.

### CROSS-REFERENCE TO RELATED APPLICATIONS

This application is based upon and claims the benefit of priority from U.S. Provisional Patent Application 61/706,653, filed on Sep. 27, 2012, the entire contents of which are incorporated herein by reference.

### TECHNICAL FIELD

This disclosure relates to electromagnetic communication systems and methods. More particularly, this disclosure relates to expanded beam connectors with targeted parameters in optical communication systems and methods.

### BACKGROUND

Advances in technology have made communication using electromagnetic waves the most reliable and fastest ways of communicating information between points. In general, electromagnetic communication systems generate information at a source (e.g., transmitter). Information is transmitted as a signal through a channel, such as free space in radio applications, electronic lines in telephone and internet applications, or optic fibers in fiber optic applications. During transmission, a channel propagating information usually induces loss in a signal and/or distorts the signal. Likewise, various other mechanics may introduce noise in a signal. A signal is typically received by a receiver which can utilize and/or decode the signal.

Since the 1960's optical systems utilizing light beams to carry information, or fiber optics, have experienced a heightened interest and increasing amounts of applications. This interest and increase in applications can be traced to the development of laser technologies and advanced carrier channels. For example, laser diodes (LDs) and light-emitting diodes (LEDs) represented sources capable of providing a single intense light source small enough for optical applications. Likewise, optic fibers made of high purity glass or plastic provided carriers with measured attenuation at less than 20 decibels (dB) per kilometer (km).

In today's optics, an optic engine or transmitter utilizes a laser diode (LD) or light-emitting diode (LED) to encode data through modulation, such as amplitude modulation (AM), frequency modulation (FM), and digital modulation. LD and LED sources commonly generate signals with wavelengths in a range from 660 nanometers (nm) to 1,550 nm. Encoded data is propagated through an optic fiber (e.g., silicon). Optic fibers couple to an optical receiver which detects, amplifies, and decodes (demodulates) the encoded data.

Interconnection devices join an optic fiber to another optic fiber or to a fiber optic component (e.g., transmitter or receiver). A common interconnection device is a connecter. Connecters are typically used to couple an optic fiber or optic component that may need to be decoupled in the future. Connectors and interconnection devices, in general, introduce additional loss in communication systems.

The above-described deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods for electromagnetic communication systems. In an aspect, an optical signal parameter is altered to meet a target range to decrease sensitivity, increase density, and/or alter a communication. For instance, by limiting a diameter of an expanded optical beam more channels can be stacked (in parallel or otherwise) in a smaller space for a given form-factor (e.g., bandwidth and/or density can be increased). Likewise, expanding a beam to a size which is not effected by occlusions too small to be visible to a human eye can allow for identification and removal of occlusions or contaminants without need to power on a system or use imaging tools.

Various non-limiting embodiments of a system and method for facilitating electromagnetic communication through a carrier are disclosed herein. In one particular embodiment, a method for determining an optimal or near optimal beam size to simplify connections and optimize bandwidth in electromagnetic systems is provided. The method includes applying various algorithms to determine a target beam size. Within such embodiment, characteristics of common and/or expected occlusions can be considered. The method further includes propagating a signal through a carrier and expanding the signal based on the determined target and/or thresholds.

The following description and the annexed drawings set forth detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates an exemplary communication system in accordance with an aspect of the subject specification.

FIG. 2 illustrates an enlarged cross sectional diagram of an exemplary device that facilitates identification of occlusions and signal expansion.

FIG. 3 illustrates an exemplary diagram of an optic beam expansion and refocusing system in accordance with an aspect of the subject specification.

FIG. 4 is a schematic diagram illustrating an exemplary interconnection component for optical communication in accordance with an aspect of the subject specification.

FIG. 5 is a schematic diagram illustrating an exemplary interconnection component for optical communication with a ribbon carrier in accordance with an aspect of the subject specification.

FIG. 6 illustrates an exemplary graph of a particular produced by a particular methodology for determining a threshold parameter in accordance with an aspect of the subject specification.

FIG. 7 illustrates an exemplary graph of a particular produced by a particular methodology for determining a beam parameter in accordance with an aspect of the subject specification.

FIG. 8 illustrates an exemplary flowchart of a particular methodology for operating a communication system in accordance with an aspect of the subject specification.

FIG. 9 illustrates an exemplary flowchart of a particular methodology for operating an interconnection system in accordance with an aspect of the subject specification.

FIG. 10 illustrates an exemplary flowchart of a particular methodology for configuring a communication system in accordance with an aspect of the subject specification.

FIG. 11 illustrates an example schematic block diagram of a communication environment in accordance with various aspects of this disclosure; and

FIG. 12 illustrates an example block diagram of a computer operable to execute various aspects of this disclosure.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident; however, that such matter can be practiced without these specific details. In other instances, well-known structures and devices are shown in block diagram form in order to facilitate describing the claimed subject matter.

As utilized herein, terms “component,” “system,” “data store,” “engine,” “template,” “manager,” “network,” “profile,” and the like are intended to refer to a computer-related entity, either hardware, software (e.g., in execution), and/or firmware. For example, a component can be a process running on a processor, a processor, an object, an executable, an optical device, an electronic device, a holographic device, a mechanical device, a function, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The terms “signal,” “optical signal,” “beam,” “optical beam,” and the like are intended to encompass an electromagnetic signal in various forms and can include signals along the electromagnetic spectrum. For brevity, this disclosure refers to the various systems and methods as relating to optical systems and/or methods. In addition, the terms “carrier,” “cable,” “optical fiber,” “optic fiber,” “fiber,” “free space.” and the like, are intended to encompass mediums which allow propagation of electromagnetic signals. As such, the above should not be seen as a limit to optical systems and/or methods. For example, a carrier may be a braided copper wire allowing propagation of electromagnetic signals. The terms “lens,” “optic lens,” “beam expander,” “refocusing component.” and the like are intended to encompass holographic devices, mechanical devices, mirrors, convex and/or concave lenses, plastic lenses, glass lenses, and the like. Of course, those skilled in the art will recognize many modifications may be made to this configuration without departing from the scope or spirit of the claimed subject matter. Additionally, the terms “communication system,” “communication method,” “communication,” “propagate,” “send,” and the like are intended to encompass any transmission of a signal, over any distance, and through any carrier. For example, a communication system can be between a relatively short distance from one integrated circuit to another integrated circuit or relatively large distances, such as kilometers between telecommunication stations.

Moreover, the word “exemplary” is used herein to mean serving as an example, instance, or illustration. Any aspect or design described herein as “exemplary” is not necessarily to be construed as preferred or advantageous over other aspects or designs.

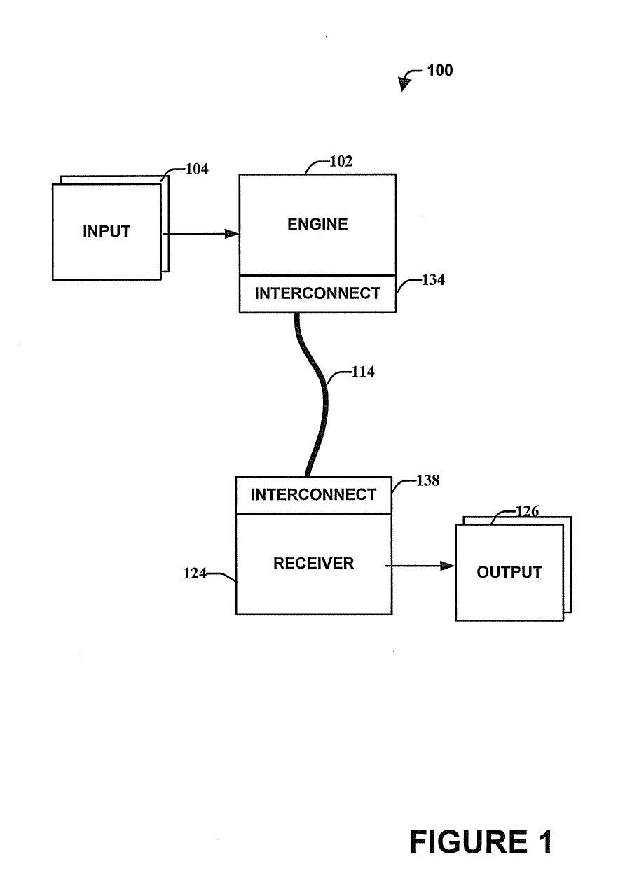

Referring now to FIG. 1, an optical communication system 100 capable of high density transmission and low loss per interconnection is illustrated in accordance with various embodiments presented herein. System 100 comprises an engine 102 capable of receiving input 104, carrier 114, receiver 124 capable of generating output 126, and connectors 134 and 138. It is appreciated that additional components are inherent to system 100 but are not illustrated for simplicity and readability.

Engine 102 can transform input 104 to optical signals (e.g., light). For example, engine 102 can receive input 104. Input 104 can comprise electrical signals, radio frequencies, optical signals, and/or other various forms of input. In one aspect, input 104 can correspond to signals sent from a computer processor, integrated circuit, radio transceiver, a user, and the like.

Engine 102 can include transmitters and circuitry capable of transforming input 104 to an optical signal, such as substrate/optoelectric components, electrical interfaces, component arrays, data encoders, modulators (amplitude modulation, frequency modulation, and/or digital modulation), and light sources, for example. In one aspect, engine 102 includes one or more light emitting sources, such as a laser diode (LD), light emitting diode (LED), surface-emitting LEDs (SLEDs), edge-emitting LEDs (ELEDs), Fabry-Perot (FP) LDs, buried hetro (BH) LDs, multi-quantum well (MQW) LDs, distributed feedback (DFB) LEDs, and the like. A light emitting source can produce light signals by transforming electrical, or other signals, into an optical signal. In one implementation, a collimated beam is produced. A collimated beam is light with parallel rays. The rays of a collimated beam spread slowly as the beam propagates (e.g., via carrier 114). While laser light from gas or crystal lasers naturally collimates, LDs do not naturally emit collimated light. Accordingly, when using LD sources, engine 102 can include collimating lenses that collimate the LD. The collimating lenses can include parabolic mirrors, spherical mirrors, or other types of lenses that produce collimated light from point-like sources.

Carrier 114 can carry the optic signals between two points. In one aspect the optic signal propagates from engine 102 to receiver 124. Carrier 114 can be single-mode fiber, multi-mode fiber, step-index fiber, or graded-index fiber. Likewise, carrier 114 can include doped glass cores, quartz, pure fused silica, plastic, and other materials allowing propagation of optical signals. Carrier 114 can also be of one or more optic cable construction, including but not limited to, simplex cable construction, duplex zipcord cable construction, multifiber breakout cable construction, hybrid cable construction, optical ribbon construction, submarine cable construction, and the like. In one example, carrier 114 includes one or more interconnection devices. An interconnection device may include connectors, comprising ferrules, connector bodies, cables, lenses, optical signal expanders and the like. In another aspect, carrier 114 can be connected to multiple receivers, carriers, or other devices. As such, carrier 114 can include connectors, splicers, couplers, splitters, tap ports, stitches, and wavelength-division multiplexers, for example.

Carrier 114 is coupled to engine 102 via interconnector device 134 and carrier 114 is coupled to receiver 124 via interconnection device 138. In one example, interconnection devices 134 and 138 are expanded beam connectors. Expanded beam connectors receive optical signals and expand the optical signal. In one example, the optical signal is a collimated light beam and interconnection devices 134 and 138 expand and collimate the light beam emitted by engine 102. Interconnection devices 134 and 138 can be genderless, containing a pin and a hole, or may be male or female with a mating sleeve, for example.

Interconnection devices 134 and 138 expand optical signals at an optimal (or near optimal) expansion to decrease or eliminate blocking and/or scattering resulting from occlusions while providing high density and/or the best possible density. System 100 utilizes the geometric occlusion computed to evaluate loss experienced in connectors and/or Mie scattering theory to determine an ideal expansion of an optical signal. In particular, interconnection devices 134 and 138 include optical devices which expand an optical signal as a function of the Mie scattering theory based on identified resonance peaks and the maximum extinctions which occur for particles of particular sizes, and having particular characteristics.

In one example, interconnection devices 134 and 138 expand an optical signal to a size based on the visual limits of a human eye. For example, the visual limit for the smallest particles a human eye can see is between 30 micro meters (μm) and 100 μm, for typical human eyes. Interconnection devices 134 and 138 can expand an optical signal based on a level of human visibility of particles (or groups of particles) which can form occlusions on a lens or other component. In one example, a 60 μm occlusion visibility limit is assumed to yield a resonance peak and the maximum extinction at 850 nm, which occurs at roughly 1.25 μm particle sizes. Interconnection devices 134 and 138 can expand to a beam size of roughly 200 μm diameter for opaque particles. As another example, the presence of a 60 μm particle on a lens or device is visible to a human eye as a dark or clouded occlusion, and is readily identified for removal.

In another example, interconnection devices 134 and 138 expand an optical signal to a size based in part on the visual limits of an aided human eye. Today, many magnification devices are readily available at low costs, such as microscopes, digital imaging devices (included in smart phones and cameras, for example), magnifying glasses, eye glasses, magnifying lenses, and the like. Accordingly, interconnection devices 134 and 138 can expand an optical signal to decrease the impact of occlusions not visible to a human eye aided by a magnification device, even a low powered magnification device, while maximizing bandwidth by enabling more channels to be stacked (in parallel) in a smaller space (e.g., increase density).

In one aspect, interconnection devices 134 and 138 are less sensitive to contamination via occlusions, are less effected by misalignment and vibration than physical contact (PC) connectors, are more consistent in repeated matings than PC connectors, and do not contact optical elements of mated connectors.

Further, interconnection devices 134 and 138 allow for increased channel density, compared to other connectors, without being sensitive to loss as a function of the presence of contaminants. Interconnection devices 134 and 138 also allow for increased usability, installation, and easier identification of contaminants, as compared to previous connectors.

In another aspect, interconnection devices 134 and 138 designed via application of Mie scattering theory can have an actual performance between -1 decibel (dB) extinction loss and the pure absorption loss for the largest particle size (geometric occlusion). Accordingly, interconnection devices 134 and 138 can expand a beam to the smallest size that can be used to make high density connectors.

In one aspect, Mie scattering theory can be used to find the intensity of scattered radiation. The intensity of Mie scattered radiation is given by the summation of an infinite series of terms rather than by a simple mathematical expression. It can be shown, however, that Mie scattering is roughly independent of wavelength and it is larger in the forward direction than in the reverse direction. The greater the particle size, the more of the light is scattered in the forward direction. In another aspect Debye series and Rayleigh scattering theory can be utilized to determine an appropriate size to expand an optic signal.

In another aspect, Receiver 124 can receive an optic signal propagated through carrier 114. In one example, a receiver can decode the optic signal into another form, such as an electrical signal, for example. Receiver 124 can include detectors, such as PIN photodiodes or avalanche photodiodes, comprising silicon, indium gallium arsenide, or germanium, for example. Receiver 124 can also include decoders, demodulators, amplifiers, electrical interfaces, and other circuitry. In one example, decoders and demodulators decode/demodulate via the same standard used by encoders and modulators in engine 102. However, it is appreciated that various decoders, demodulators, encoders, and modulators can be utilized.

In yet another aspect, receiver 124 includes one or more carriers capable of propagating optical signals. For example, receiver 124 can include an optical fiber coupled to carrier 114. In another example, receiver 124 can include various coupled optical fibers, and one or more receiver components.

In various embodiments, receiver 124 can generate output 126. For example, receiver 124 can generate output 126 by converting an optical signal into an electrical signal, video signals, audio signals, over the air signals, binary signals, encrypted signals, cellular signals, telephonic signals, and the like. In one aspect, output 126 can be transmitted to additional carriers, data centers, processing units, user devices, laptops, personal computers, smart phones, tablets, personal digital assistants, video game consoles, telecommunication devices and service centers, broadcast stations, televisions, digital video recorders, set top boxes, routers, modems, and the like.

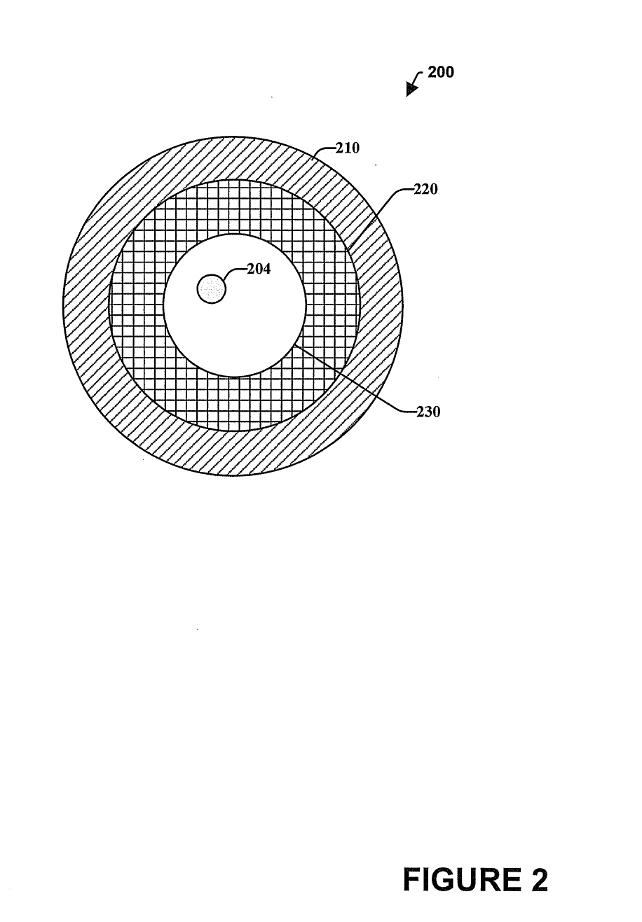

Referring next to FIG. 2, an illustration of an exemplary optical fiber carrying an optical signal and having a contaminated surface in accordance with an aspect of the subject specification is provided. As illustrated, an optical system 200 includes a buffer component 210, a cladding component 220, and a fiber end surface component 230 having an occlusion 204. Here, it should be appreciated that optical system 200 may be implemented as a single-mode fiber or multi-mode fiber. Similarly, it should be further appreciated that each of components 210, 220, and 230 may be implemented as single devices and/or multiple devices. Further, optic system 200 is illustrated as simplex cable for simplicity and readability, and should be read to include duplex zipcord cables, multifiber breakout cables, hybrid cables, optical ribbon cables, submarine cables, and the like. Further, fiber end surface component 230 is understood to be a surface on a fiber optic core, beam expansion component, passive optical part, lens, and/or other applicable optical component. As such, optical system 200 can include additional buffer, cladding, and fiber end surface components.

In an embodiment, buffer component 210 provides insulation and protection for a fiber core. In one aspect, buffer component 210 can be of a plastic or rubber construction. In some implementations, buffer component 210 may be stripped to expose portions of cladding component 220 and/or a fiber optic core.

Cladding component 220 can reflect optical signals back into a fiber optic core. In one aspect, the cladding component is the same material as a fiber optic core (e.g., doped glass or silica). However, the cladding component can be a different material than that of a fiber optic core. In another aspect, the cladding component comprises a material with a refractive index of a disparate value than a fiber optic core.

Fiber end surface component 230 represents a terminal end of a fiber optic core. Fiber end surface component 230 can be a direct end of a fiber optic core, a polished end, a lens, a component of a connector (beam expansion component), and the like. Fiber end surface component 230 is drawn for simplicity, without additional structures (such as a connector housing or ferrules).

In one example, an expanded beam may be emitted from end surface component 230. However, it is appreciated that fiber end surface component 230 may receive an expanded beam and collimate the expanded beam, to allow for propagation through a fiber core. In one aspect, an expanded beam's size is determined via Mie scattering theory and/or geometric occlusion methods. For example, Mie scattering theory can be applied to determine an expansion size that allows system 200 to increase density (and/or bandwidth), while not being effected by an occlusion smaller than occlusion 204. Occlusion 204 represents a particle or group of particles contaminating fiber end surface component 230.

In this example, occlusion 204 is i μm, where i is a real number from 30 to 100 (e.g., the typical expected visual limit of an unaided human eye). Further, it is assumed that a value less than i is not visible to the unaided human eye. Fiber end surface component 230 is configured to expand a beam based on Mie scattering theory, geometric occlusion, and visual limits of an unaided human eye, such that an expanded beam size is not greater than needed to avoid loss from particles smaller than i μm.

In another example, occlusion 204 is readily visible to an unaided human eye. Occlusion 204 may represent a dust particle, moisture droplet, dirt, organic material, and/or other contaminant. Since occlusion 204 is visible to an unaided human eye, occlusion 204 may be identified, cleaned and/or removed from fiber end surface component 230 without need for additional tools.

In another example, occlusion 204 is readily visible to an aided human eye. A tool or magnification device may be used to magnify an area of fiber end surface component 230, thus making occlusion 204 visible. Accordingly, a visual limit of a human eye may be increased, for example to 10 μm. The tool or magnification device may be an inexpensive magnification device, such as a plastic magnifying glass. Likewise, the tool or magnification device may be a low powered, relatively low resolution device. Accordingly, expensive and delicate devices are not needed to clean, identify, and/or remove occlusion 204.

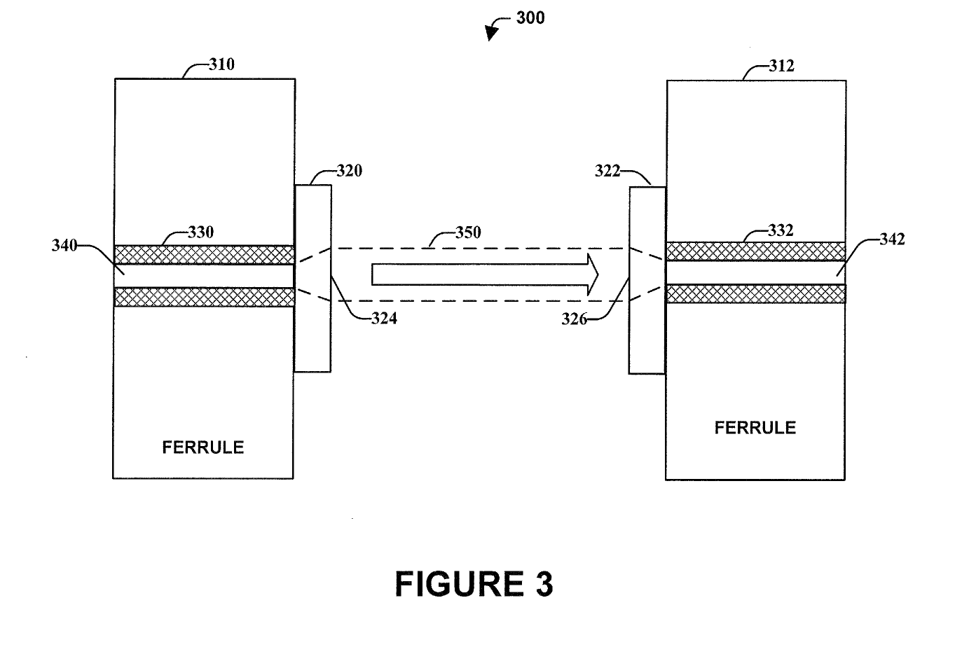

Referring next to FIG. 3, a cross-sectional diagram is provided of an exemplary expanding beam and focusing beam coupling system 300 for coupling two optical components in accordance with an aspect of the subject specification. As illustrated, system 300 includes ferrule bodies (310, 312), lens components (320, 322), end surfaces (324, 326), passages (330, 332), fiber cores (340, 342), and optical beam 350.

Ferrule body 310 and ferrule body 312 are depicted as mated with open space between them. In one aspect, ferrule bodies 310, 312 can each be of a single monolithic construction comprising molded plastic, metal, and/or organic materials. In another aspect, ferrule bodies 310, 312 can each be composed of multiple pieces. Further, ferrule bodies 310, 312 are positioned anti-parallel (e.g., in mirror image, of each other). Likewise, while ferrule bodies 310, 312 are depicted with lens components 320, 322 connected at right angles, it is appreciated that lens components 320, 322 may be joined with ferrule bodies 310, 312 in an angular construction. In addition ferrule bodies 310, 312 can comprise one or more guidepin holes (not shown) into which guidepins of other ferrules are retained or received.

Ferrule bodies 310, 312 depict passages 330, 332 allowing fiber cores 340, 342 passage through ferrule bodies 310, 312. It is appreciated that ferrule bodies 310, 312 can allow for multiple passages, carrying multiple fiber cables. Likewise, passages 330, 332 can be of varying size and shape. This disclosure will generally refer to passages 330, 332 as being cylindrical and having a diameter, for simplicity.

In another aspect, passages 330, 332 can allow one or more fiber cores 340, 344 of various construction (e.g., doped glass cores, quartz, pure fused silica, plastic) and/or size (e.g., 9/125 μm, 50/125 μm, 62.5/125 μm, 100/140 μm, 110/125 μm, and 200/230 μm. In an implementation, passages 330, 332 sizes and positions are determined based on a specific fiber type (e.g., singlemode fiber). In another aspect, alternative embodiments may use other ferrule styles and/or multimode fiber. Other ferrule styles may have a different number of fiber conductors in a ferrule. Fiber passages may have differing relative orientations and may have different centering parameters.

In one aspect, fiber cores 340, 344 and ferrule bodies 310, 312 may terminate at lens components 320, 322. Lens components 320, 322 can include a chip affixed to ferrule bodies 310, 312. Lens components 320, 322 can also include one or more optical devices to expand and/or collimate optical beam 350. Lens components 320, 322 can include diffractive optics and/or standard dioptric lenses (e.g., 3 mm ball lens).

In one embodiment, lens components 320, 322 contain an array of optic beam expanders (such as a holographic array). In another aspect, the array is aligned with a number of fiber cores (e.g., fiber core 340, 342).

As depicted, an optical signal is propagated through fiber core 340 and is expanded via lens component 320 to a target range. Optic beam 350 propagates through free space from end surface 324 to end surface 326. Lens component 322 collimates or refocuses optic beam 350 and a corresponding optic signal propagates through optic core 342. While optic beam 350 is depicted as unidirectional (e.g., traveling from left to right), it is appreciated that optic beam 350 can travel in the opposite direction, and components 310, 312, 320, 322, 324, 326, 330, 332, 340, and 342 can perform similar but reverse functions. Likewise, optic beam 350 and components 310, 312, 320, 322, 324, 326, 330, 332, 340, and 342 can allow for multi-directional communication.

In one aspect, an expanded beam's size is determined via Mie scattering theory and/or geometric occlusion methods. For example, Mie scattering theory can be applied to determine an expansion size that allows a system 300 to increase density (or bandwidth), while not being effected by an occlusion smaller than a human eye can see. In one example, an optic signal propagated through fiber core 340 is expanded via lens component 320 into optic beam 350 to a size based on Mie scattering theory, geometric occlusion, and visual limits of an unaided human eye, such that an expanded beam size is not greater than needed to avoid loss from particles smaller than a human eye's visual limits (30 μm-100 μm in diameter, although an alternative range from 40 μm-80 μm in diameter is also possible). While diameter is used to describe particle size, it is appreciated that particles can be of a shape not having a diameter; however diameter is used for brevity.

In another aspect, lens component 322 can refocus optic beam 350. In one aspect, optic beam 350 is expanded such that an occlusion that is lower than the visual limits of a human eye will not cause reduction in signal loss during refocusing optic beam 350.

In another aspect, lens components 320, 322 can be cleaned of occlusions, such as dust particles, moisture droplets, dirt, organic material, and/or other contaminants. Since occlusions not visible to an unaided human eye do not effect loss, attenuation or degradation in the optic signal, lens components 320, 322 can be cleaned without use of an imaging device.

In one example, Mie scattering theory can be applied to determine an expansion size that allows beams to be densely stacked in a space for a given form factor thereby increasing density (and/or bandwidth), while not being effected by an occlusion smaller than an aided human eye can see. For example, a tool or magnification device may be used to magnify an area of lens components 320, 322, thus making occlusions visible. Accordingly, a visual limit of a human eye may be increased by a tool, for example to 20 μm. A tool or magnification device may be an inexpensive magnification device, such as a plastic magnifying glass. Likewise, a tool or magnification device may be a low powered, relatively low resolution device. Accordingly, expensive and delicate devices are not needed to clean, identify, and/or remove occlusion from system 300.

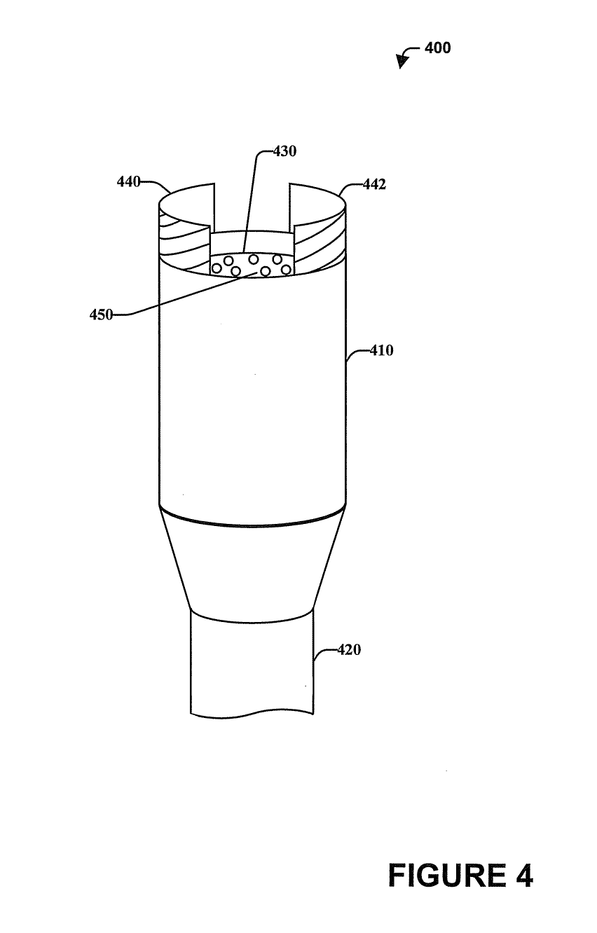

Referring next to FIG. 4, a fragmented diagram of an exemplary expanding beam and/or focusing beam interconnection system 400 in accordance with an aspect of the subject specification is provided. As illustrated, system 400 includes body 410, carrier 420, end surfaces 430, connection components 440, 442, and expanding components 450. It is appreciated that system 400 can be of various shapes and configurations, and system 400 is depicted as an exemplary embodiment of a system in accordance with aspects of this disclosure.

Body 410 can comprise a housing or assembly containing various components. In one aspect, body 410 can contain an outer shell or casing of singular or modular construction. In another aspect, body 410 can be composed of one or more substances (e.g., plastic, rubber, glass, metal, organic). At one end, body 410 can receive carrier 420. Carrier 420 can be joined to body 410 via various means and/or can be considered as a unitary construction. At end surface 430, body 410 can terminate and can contain various components coupled to or extruding from body 410. For example, connection components 440, 442 can be coupled to body 410 and can be considered to extrude from body 410.

Carrier 420 is capable of communicating electromagnetic signals (e.g., optical signals). In one example, carrier 420 is an optical fiber comprised of one or more fiber optic cores, in accordance with various aspects of this disclosure. As another example, carrier 420 allows an electromagnetic signal to propagate from a source to body 410 and/or from body 410 to a destination.

Connection components 440, 442 can connect system 400 to additional components (e.g., another system 400, receiving components, transmitting components). As depicted, connection components 440, 442 are screw-type connection components. However, connection components 440, 442 can be of various constructions depending on the desired type of interconnection device. In another aspect, connection components 440, 442 may be a male connection, female connection, or both.

In one aspect, end face 430 contains a number of expanding components 450. Expanding components 450 can be attached to, or included in end face 430 in any appropriate manner. In one aspect, expanding components 450 comprise a set of z expanding components, where z is a real integer. Likewise, system 400 can comprise x optic cores, where x is a real integer. In another aspect, expanding components 450 can send/receive y signals, where y is a real integer. In one aspect, x, y, and z may be identical but need not be.

Expanding components 450 can include a number of different expanding or focusing components, including diffractive optics, standard dioptric lenses, ball lens, holographic arrays, concave/convex lenses, mirrors, and the like. The desired expanding and focusing components can be configured according to desired aspects of system 400.

In one example, expanding components 450 can receive, collimate and/or refocus signals. For example, system 400 can be mated to a connector, the connector sends collimated or optic beams to system 400 and are received by one or more of the expanding components 450. In one aspect, expanding components 450 can refocus the one or more optic beams. In another aspect, expanding components 450 can be aligned to receive signals.

In another example, expanding components 450 can send and/or expand signals. For example, system 400 can be mated to a connector, the connector can receive collimated optic beams to be expanded by expanding components 450. In one aspect, expanding components 450 can expand the one or more optic beams to desired target sizes (e.g., to desired diameters in optical implementations).

In one aspect, target beam sizes are determined via Mie scattering theory and/or geometric occlusion methods. For example, Mie scattering theory can be applied to determine an expansion size that allows system 400 to increase density (or bandwidth), while not being effected by an occlusion smaller than a human eye can see. In one example, optic signals propagated through a fiber core and expanded via expanding components 450 to target sizes based on Mie scattering theory, geometric occlusion, and visual limits of an unaided human eye, such that an expanded beam size is not greater than needed to avoid loss from particles smaller than a human eye's visual limits (30 μm-100 μm in diameter). While diameter is used to describe particle size, it is appreciated that particles may be of a shape not having a diameter; however diameter is used for brevity.

In one example, Mie scattering theory can be applied to determine an expansion size that allows a system to add additional beams in a space to increase density (or bandwidth), while not being effected by an occlusion smaller than an aided human eye can see. For example, a tool or magnification device may be used to magnify an area of lens components 420, 422, thus making occlusions visible. Accordingly, a visual limit of a human eye may be increased by a tool, for example to 20 μm. A tool or magnification device may be an inexpensive magnification device, such as a plastic magnifying glass. Likewise, a tool or magnification device may be a low powered, relatively low resolution device. Accordingly, expensive and delicate devices are not needed to clean, identify, and/or remove occlusions from system 400.

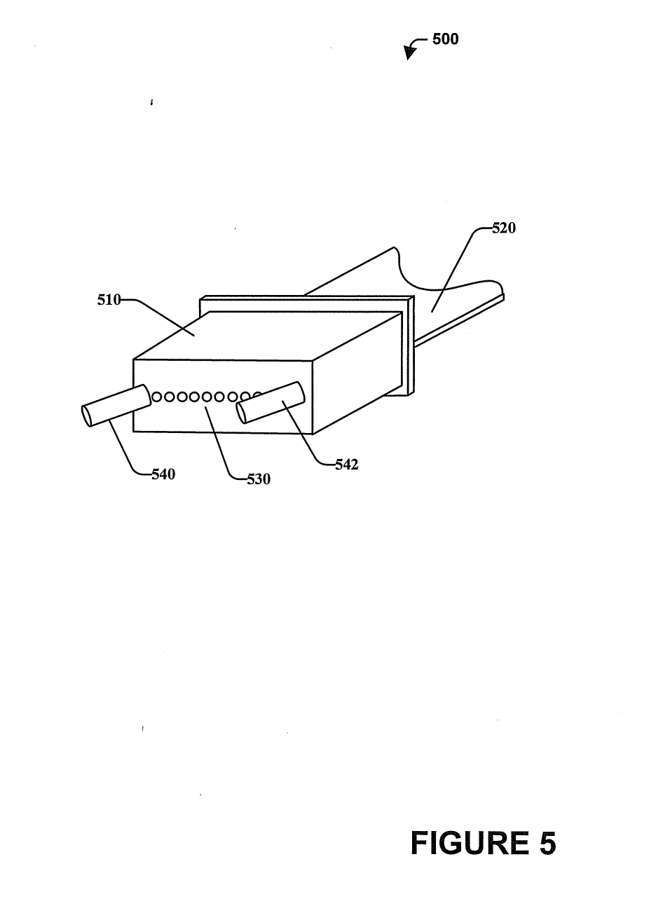

Turning to FIG. 5, a fragmented view of an assembled MT type interconnection system of an exemplary expanding beam and/or focusing beam system 500 in accordance with an aspect of the subject specification is provided. As illustrated, system 500 includes body 510, carrier ribbon 520, lens array 530, and connection components 540, 542. It is appreciated that system 500 can be of various shapes and configurations, and system 500 is depicted as an exemplary embodiment of a system in accordance with aspects of this disclosure.

In one embodiment, body 510 has twelve (12) passages appropriately sized and positioned to receive fibers from carrier ribbon 520. Alternate embodiments may use other ferrule styles, fiber types, various numbers of passages, and channels. Other ferrule styles may have a different number of fiber conductors in body 510. Further, passages may have differing relative orientations. In another aspect, system 500 also comprises two guidepin holes (not shown) into which connection components similar to connection components 540, 542 are retained or received.

Connection components 540, 542 may or may not be parallel to internal passages. Moreover, connection components 540, 542 can be of various shapes, lengths, and construction, depending on desired configurations. In one aspect, connection components 540, 542 are capable of being received by a second ferrule or connection to provide a secure coupling to optic components, such as fiber optic cables, passive optical devices, transmitters, receivers and the like.

Carrier ribbon 520 has twelve fibers connected via a web and is affixed to body 510. Carrier ribbon 520 can comprise a number of optic cores internal to carrier ribbon 520. In one aspect, the number of optic cores can be equal to a number of lenses in lens array 530.

In one example, lens array 530 comprises 12 (twelve) lenses formed as a holographic array, for example. However, the number of lenses and the type of lens may vary. In one example, lens array 530 is designed to align with the optic cores propagating optic signals to a terminal end of body 510. In one embodiment, lenses of the lens array 530 can receive an optical beam and/or expand an optic beam. Alternate embodiments may include a chip having lens array 530 oriented and configured for the desired ferrule, fiber, wavelength, and wavelength range of transmitted light.

In one aspect, lens array 530 can expand optic signals into collimated beams. In one example, lens array 530 alters optic signal parameters to target ranges and/or thresholds. A threshold and/or target associated with a parameter of the expanded optic signals (e.g., size, diameter) can be met by expanding optic signals in accordance with various aspects of this disclosure. For example, a target diameter can be determined based on Mie scattering theory such that any occlusion, with a size below visual limits of an unaided human eye, on lens array 530 will not affect signals passed through an expanded beam.

In another example, a parameter threshold and/or target can be associated with a particular type of occlusion, such as dust, sand, dirt, moisture, organic material, and the like. For example, different types of occlusions may have different characteristics (e.g., size, transparency, shape, density, and the like) affecting a target threshold. Accordingly, lens array 530 can alter a parameter of optic signals as a function of occlusion type and/or environment. For example, system 500 may be deployed in various environments (deserts, offices, aquatic environments, and the like). The various environments may be associated with specific types of occlusions based on the relative occurrence of the types of occlusions as compared to other various environments. In one example, lens array 530 is configured to expand optic beams based on a level of transparency and particle size of dust.

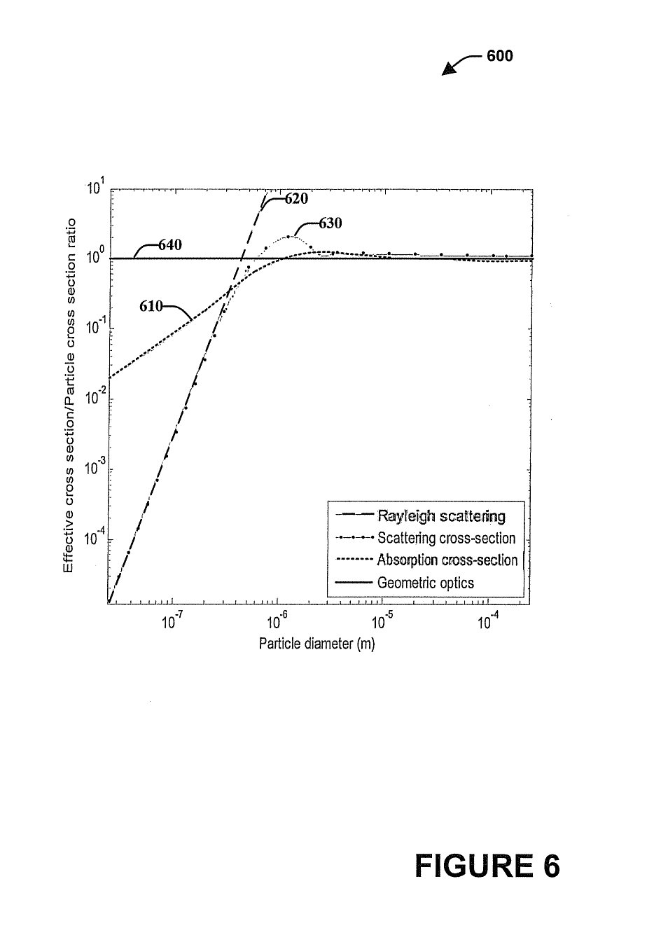

Referring next to FIG. 6, a graph is provided illustrating an effective cross section/particle cross section ratio versus diameter for a particle is depicted in accordance with an aspect of the subject specification. For this particular graph 600, absorption cross-section 610, Rayleigh scatter 620, scattering cross section 630 and geometric optic 640 are depicted. As illustrated, a logarithmic ratio is depicted along they y-axis. A particle diameter is depicted along the x-axis in meters (m). In one aspect, graph 600 can be used to determine a particle size and corresponding loss, scattering, and/or absorption.

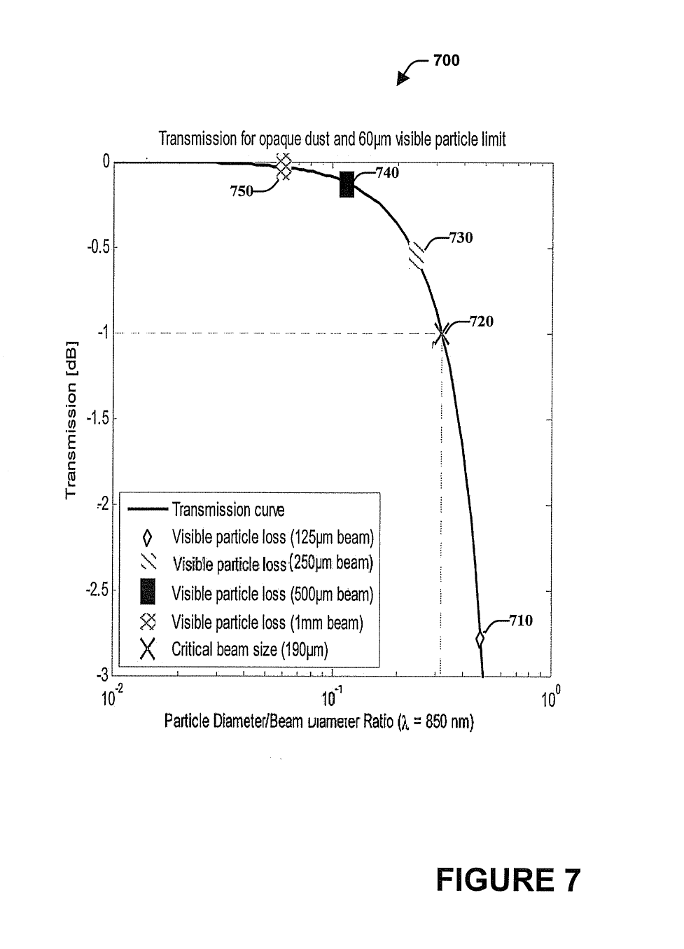

Referring next to FIG. 7, a graph is provided, illustrating an exemplary transmission for opaque dust based on an assumed 60 μm visible particle limit for a human eye is depicted in accordance with an aspect of the subject specification. As illustrated, graph 700 depicts transmission in dB along the y-axis and a particle/beam diameter ratio along the x-axis. For readability, losses at particular beam sizes are identified, including loss at 125 μm beam size 710, loss at 250 μm beam size 720, loss at 500 μm beam size 730, loss at 190 μm beam size 740, and loss at 1 mm beam size 750.

In this example, visible limit of dust particles at a critical resonant size is known. Further, loss can be limited between −dB extinction loss and pure absorption loss for a particle size (e.g., geometric occlusion). Accordingly, graph 700 can be interpolated to determine a critical beam size, in this example, 190 μm diameter (or about 200 μm). It is appreciated that graph 700 should be considered with additional particle types and at additional visible particle limits. As such, setting different parameters of an occlusion, visual limits, and the like can alter a target range for beam expansion size. Accordingly, various examples determine a target range can be between about 160 μm and about 250 μm. However, the systems and methods can determine additional target ranges.

In this exemplary graph, a visual limit of the human eye is assumed to be 60 μm (e.g., the human eye can see a 60 μm particle in diameter but not smaller). Further, opaque dust is considered a source of occlusion.

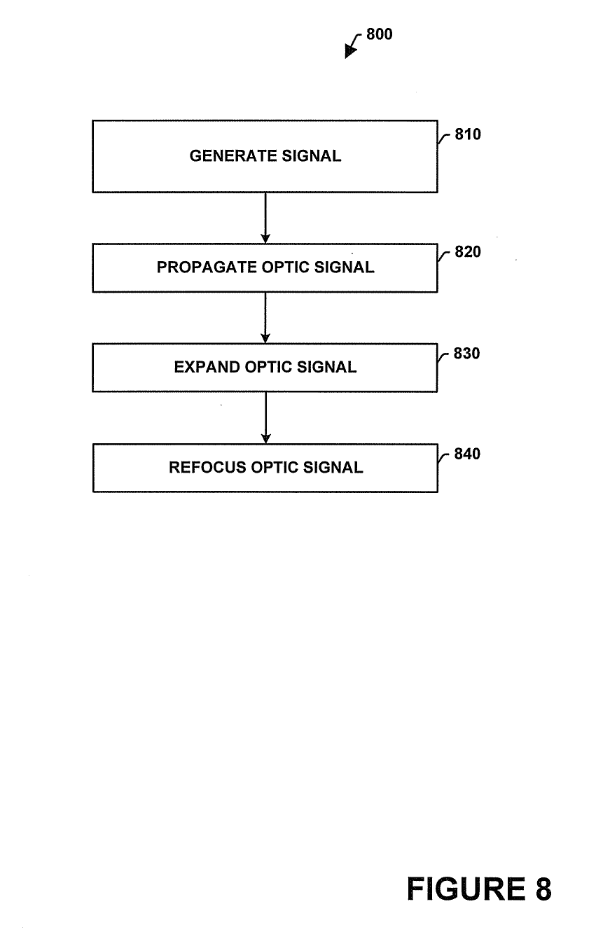

Referring next to FIG. 8, a flowchart of an exemplary methodology for communicating optic signals by utilizing an expanded beam is provided. As illustrated, process 800 begins at step 810 where a signal is generated. Here, it is thus assumed that a signal, generated by a device, will be sent over a carrier (e.g., an optic signal generator). It is appreciated that various types of signal generators, generating various types of signals can be used to generate one or more signals.

Next, at step 820, process 800 continues with propagating a signal through a carrier. Here, it should be appreciated that a signal can encompass signals covering various ranges of the electromagnetic spectrum. Further, one or more signals may propagate simultaneously, consecutively, and/or independently.

Once a signal is generated and propagates, process 800 continues to step 830 where a signal is expanded to a certain threshold. Here, it should be appreciated that such signal may be expanded via various mechanisms. Additionally, the signal may be expanded based on Mie scattering theory, visual limitations of a human eye, geometric occlusion, and the like.

And finally, at step 840, process 800 concludes with the expanded signal being refocused. In an embodiment, step 840 refocuses a signal via the same mechanisms used to expand the signal at step 830.

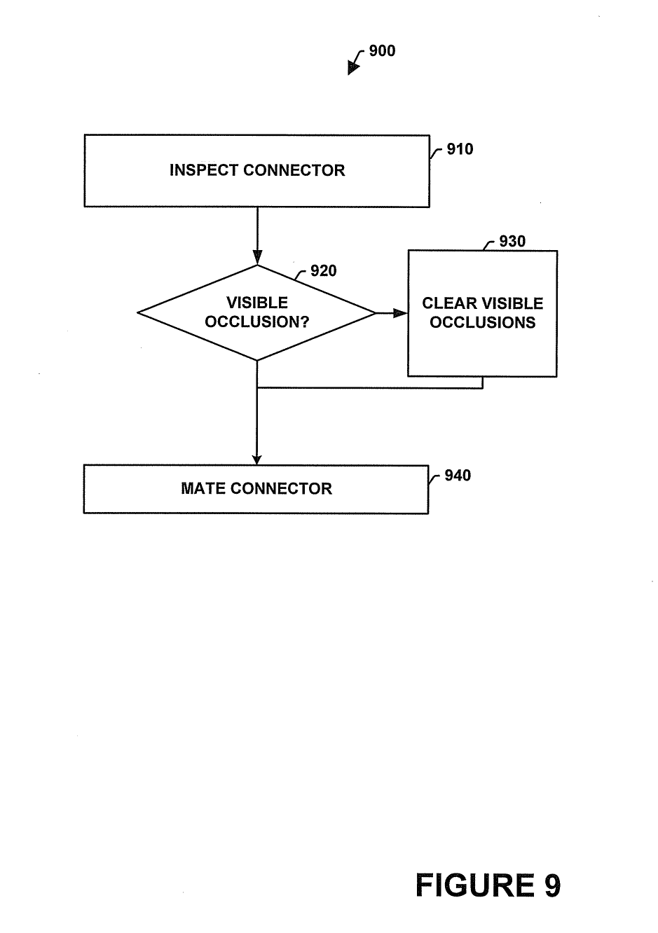

Turning to FIG. 9, a flowchart of an exemplary methodology for mating interconnection devices utilizing various aspects of this disclosure is provided. As illustrated, process 900 begins at step 910 where an interconnection device (e.g., optical connector) is inspected. Here, it is thus assumed that said interconnection device is configured in accordance with various aspects of this disclosure. It is appreciated that various types of interconnection devices may be used.

At step 920, process 900 continues with determining whether a visual occlusion is present on a lens of the interconnection device. Here, it should be appreciated that a visual occlusion can include any occlusion visible to an unaided human eye. In one aspect, an occlusion visible to the human eye can be identified without an imaging device (e.g., microscope) and without propagating a signal through an interconnection device (e.g., without the need to power on a system, such as system 100). In another aspect, occlusion which is not visible will not increase loss during communication.

If an occlusion is visible to a human eye, the occlusion is cleared from the lens at step 930 and process 900 can proceed to step 940 where the connector can be mated to an appropriate interconnection device and process 900 can terminate.

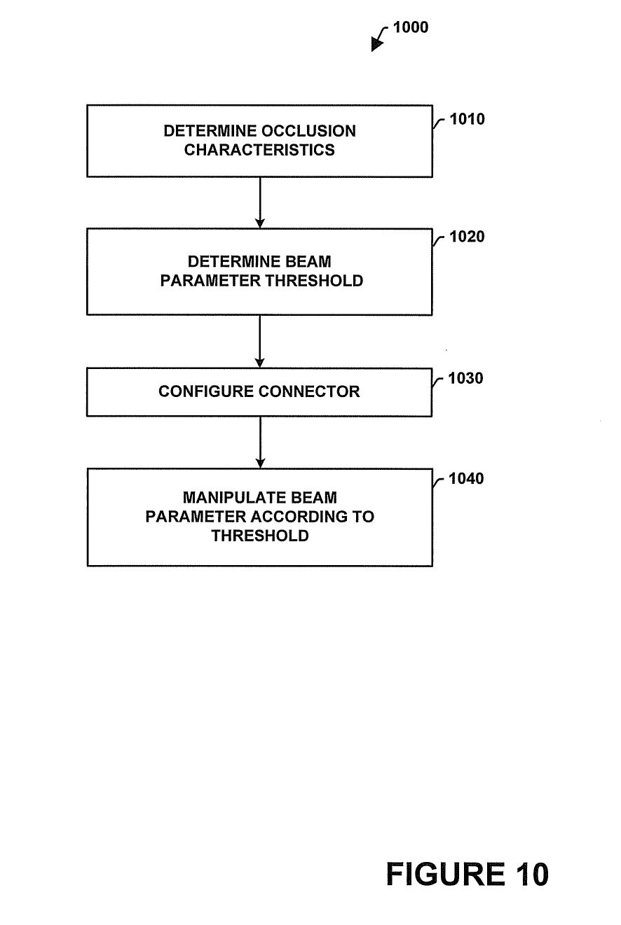

Referring next to FIG. 10, an exemplary flowchart of a particular methodology for expanding an optical beam to reduce loss to a critical −1 dB extinction and pure absorption for a large particle in accordance with an aspect of the subject specification is provided. As illustrated, process 1000 begins at step 1010 where characteristics of an occlusion are determined. In one example, a size, transparency, absorption factor, and/or scattering factor of an occlusion is determined. Once the necessary characteristics have been determined, process 1000 proceeds to step 1020 where a beam parameter threshold is determined.

At step 1020, the beam parameter threshold may be determined to increase bandwidth, reduce sensitivity, and enable visual identification of particles which may cause loss in a communication channel. In one aspect, a target parameter can be determined to encompass a range, such as a diameter from 150 μm to 220 μm. In another aspect, a target parameter can be determined to encompass a diameter from 175 μm to 210 μm. It is appreciated that a range may vary according to determined occlusion characteristics, system designs and components, and the like.

At step 1030, process 1000 continues with configuring a connector according to a parameter threshold. For example, various lenses, mirrors, holographic arrays, and the like can be configured at various angles and relative locations to an optic core to achieve a parameter threshold and/or target. Process 1000 then concludes with the manipulating a beam parameter according to the desired threshold or target value at step 1040.

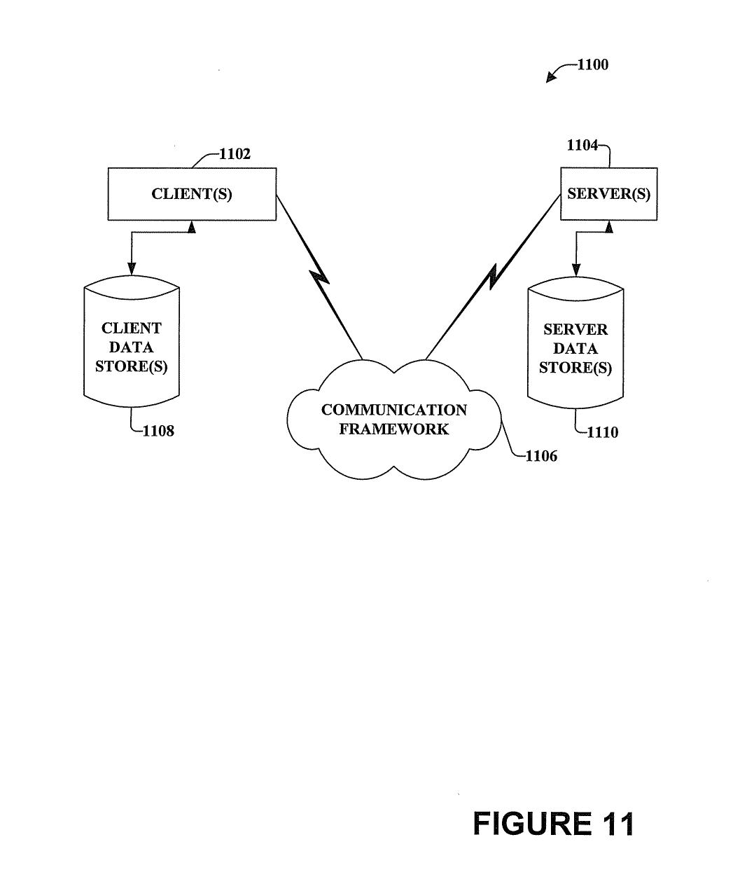

Referring now to FIG. 11, there is illustrated a schematic block diagram of a computing environment 1100 in accordance with this specification. The system 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information. The client(s) 1102 can communicate with servers(s) 1104 via optical communication systems and/or methods in accordance with various aspects of this disclosure.

The system 1100 also includes one or more server(s) 1104. The server(s) 1104 can also be hardware or hardware in combination with software (e.g., threads, processes, computing devices). The server(s) 1104 can house threads to perform transformations, for example. The server(s) 1104 can also include various memory systems. One possible communication between a client 1102 and a server 1104 can be in the form of a data packet adapted to be transmitted between two or more computer processes wherein data may be accessed or stored in accordance with aspects of this disclosure. The data packet can include a cookie and/or associated contextual information, for example. The system 1100 includes a communication framework 1106 (e.g., a global communication network such as the Internet) that can be employed to facilitate communications between the client(s) 1102 and the server(s) 1104. In one example, communication framework includes various electromagnetic communication channels, in accordance with various aspects of this disclosure (e.g., optical communication systems and/or methods).

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data stores 1110 that can be employed to store information local to the servers 1104.

In one implementation, a client 1102 can transfer data or requests to a server 1104. Server 1104 can store the data, perform requests, or transmit the data or request to another client 1102 or server 1104. At various stages, system 1100 can implement memory systems in accordance with this disclosure. For example, the client(s) 1102 and the server(s) 1104 can each implement one or more memory optical communication systems internally, in accordance with this disclosure.

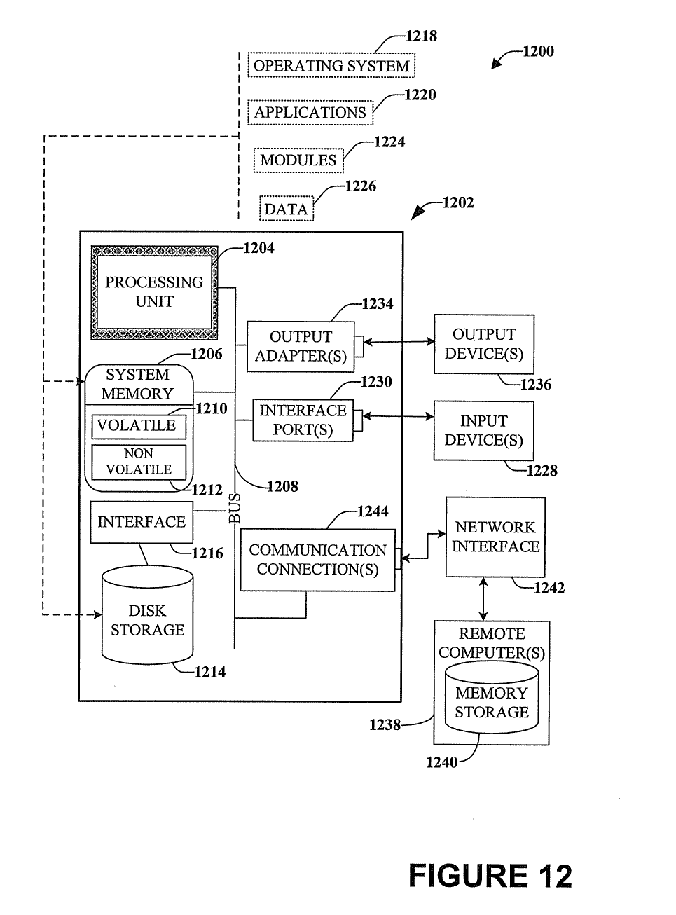

With reference to FIG. 12, a suitable environment 1200 for implementing various aspects of the claimed subject matter includes a computer 1202. The computer 1202 includes a processing unit 1204, a system memory 1206, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 can include volatile memory 1210 and non-volatile memory 1212. The basic input/output system (BIOS), containing the basic routines to transfer information between elements within the computer 1202, such as during start-up, is stored in non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDRx SDRAM), and enhanced SDRAM (ESDRAM). Volatile memory 1210 can implement various aspects of this disclosure, including memory systems containing MASCH components.

Computer 1202 may also include removable/non-removable, volatile/non-volatile computer storage media. FIG. 12 illustrates, for example, a disk storage 1214. Disk storage 1214 includes, but is not limited to, devices like a magnetic disk drive, solid state disk (SSD) floppy disk drive, tape drive, Zip drive, LS-100 drive, flash memory card, or memory stick. In addition, disk storage 1214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software, software in execution, hardware, and/or software in combination with hardware that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems. For example, applications 1220 and program data 1226 can include software implementing aspects of this disclosure.

A user enters commands or information into the computer 1202 through input device(s) 1228. Input devices 1228 include, but are not limited to; device such as a mouse, trackball, stylus, and touchpad; keyboard; microphone; joystick; game pad; satellite dish; scanner; TV tuner card; digital camera; digital video camera; web camera; and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same types of port as input device(s) 1228. Thus, for example, a USB port may be used to provide input to computer 1202, and to output information from computer 1202 to an outputdevice 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems, and DSL modems, ISDN adapters, wired and wireless Ethernet cards, hubs, and routers.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the implementations of this innovation(s), passive optical devices, and/or mechanical devices. Furthermore, it can be appreciated that many of the various components can be implemented on one or more integrated circuit (IC) chips. For example, in one implementation, a set of components can be implemented in a single IC chip. In other implementations, one or more of respective components are fabricated or implemented on separate IC chips.

What has been described above includes examples of the implementations of the present invention. It is, of course, not possible to describe every conceivable combination of components or methodologies for purposes of describing the claimed subject matter, but it is to be appreciated that many further combinations and permutations of this innovation are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive nor to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of this innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Reference throughout this specification to “one implementation” or “an implementation” or “one embodiment” or “an embodiment” means that a particular feature, structure, or characteristic described in connection with the implementation is included in at least one implementation or at least one embodiment. Thus, the appearances of the phrase “in one implementation” or “in an implementation” or “in one embodiment” or “in an embodiment” in various places throughout this specification are not necessarily all referring to the same implementation/embodiment. Furthermore, the particular features, structures, or characteristics may be combined in any suitable manner in one or more implementations/embodiments.

Further, references throughout this specification to an “item,” or “file,” means that a particular structure, feature, or object described in connection with the implementations are not necessarily referring to the same object. Furthermore, a “file” or “item” can refer to an object of various formats.

As used in this application, the terms “component,” “module,” “system,” or the like are generally intended to refer to a computer-related entity, either hardware (e.g., a circuit), a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. While separate components are depicted in various implementations, it is to be appreciated that the components may be represented in one or more common components. Further, design of the various implementations can include different component placements, component selections, etc., to achieve an optimal performance. Further, a “device” can come in the form of specially designed hardware; generalized hardware made specialized by the execution of software thereon that enables the hardware to perform a specific function (e.g., data storage and retrieval); software stored on a computer readable medium; or a combination thereof.

With respect to any figure or numerical range for a given characteristic, a figure or a parameter from one range may be combined with another figure or a parameter from a different range for the same characteristic to generate a numerical range.

Other than in the examples, or where otherwise indicated, all numbers, values, and/or expressions referring to properties, characteristics, etc., used in the specification and claims are to be understood as modified in all instances by the term “about.”

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

1. A system, comprising:
an interconnection device comprising:
a signal manipulating component configured to manipulate the signal by for altering a parameter of an electromagnetic signal to an optimal target level as a function of a characteristic of an occlusion; wherein the signal manipulating component includes at least one of: a lens, a holographic array, and a mirror.

2. The system of claim 1 further comprising:
a second interconnection device comprising a second signal manipulating component configured for focusing an electromagnetic signal, the second signal manipulating component coupled to the interconnection device.

3. The system of claim 1, wherein the parameter of the electromagnetic signal comprises a beam diameter.

4. The system of claim 1, wherein the signal manipulating component further comprises a beam expanding component configured for expanding an electromagnetic signal.

5. The system of claim 4, wherein the characteristic of the occlusion is at least one of: size, transparency, shape, density, absorption factor, and scattering factor.

6. The system of claim 1 further comprising:
an array of beam expanding components, each beam expanding component configured for altering the parameter of an electromagnetic signal.

7. The system of claim 1, wherein the target level is a function of human visual capabilities.

8. The system of claim 1, wherein the target level is a function of at least one of: Mie scattering theory, Debye series, Rayleigh scattering theory, and geometric occlusion methods.

9. The system of claim 1, wherein the interconnection device is comprised by an optical connector.

10. The system of claim 9, wherein the optical connector is configured for receiving an optical signal and launching an expanded beam through the signal manipulating component.

11. The system of claim 1, wherein the interconnection device expands an optical beam to have an expanded diameter in a range from 180 μm to 220 μm.

12. The system of claim 1, wherein the signal manipulating component is further configured for receiving an expanded beam and refocusing the expanded beam into a focused beam.

13. A method of processing an electromagnetic signal, comprising;
determining a threshold associated with a parameter of the electromagnetic signal as a function of an occlusion characteristic; and
altering the parameter of the electromagnetic signal to the threshold via an interconnection device.

14. The method of claim 13, wherein determining the threshold further comprises determining a critical size of the occlusion.

15. The method of claim 13, wherein altering the parameter further comprises expanding an optical signal to the threshold.

16. The method of claim 15, wherein the expanding optical signal is not affected by particles beyond the threshold.

17. The method of claim 13 further comprising:
using at least one optical expanding component of the interconnection device to expand an optical signal.

18. A communication system, comprising:
means for expanding an optical signal to an optimal target range;
means for coupling a first interconnection component to a second interconnection component; and
means for focusing the expanded optical signal.

19. The system of claim 18, wherein the target range is a function of geometric occlusions and Mie scattering.

20. The system of claim 18, wherein the means for expanding expands a plurality of optical signals simultaneously and the means for focusing focuses a plurality of expanded optical signals simultaneously.

21. The system of claim 1, wherein the target level is optimal when the level minimizes or maximizes the function to minimize or maximize the effect of the occlusion to achieve at least one of: increased bandwidth, reduced sensitivity, and increasing visual identification of particles.
